(19) United States
(12) Patent Application Publication
(10) Pub. No.: US 2004/0111513 A1
(43) Pub. Date: Jun. 10, 2004

(54) Automatic employment of resource load information with one or more policies to automatically determine whether to decrease one or more loads

(76) Inventor: Simon S. Shen, Naperville, IL (US)

Correspondence Address: PATTI & BRILL, ONE NORTH LASALLE STREET, 44TH FLOOR, CHICAGO, IL, 60602, US

(21) Appl. No.: 10/309,579

(22) Filed: Dec. 4, 2002

(51) Int. Cl. G06F 15/173

(52) U.S. Cl. 709/226

(57) ABSTRACT

An apparatus in one example comprises one or more policies, a director component, and a control component. The one or more policies comprise one or more dynamically-updateable policies and zero or more fixed policies. The director component automatically employs information about one or more of a plurality of loads on a resource in conjunction with the one or more policies to automatically determine whether to decrease one or more loads of the one or more of the plurality of loads on the resource. Upon determination by the director component to decrease the one or more loads the director component automatically prepares an instruction to decrease the one or more loads. The control component, upon receipt of the instruction from the director component, automatically decreases the one or more loads on the resource. The one or more dynamically-updateable policies are changeable contemporaneously with active operation of the director component with the control component.

### TECHNICAL FIELD

The invention relates generally to workloads and more particularly to resource employment in load handling.

### BACKGROUND

Various systems employ resources to handle loads. Capabilities of a central processing unit (“CPU”) board or card comprise one example of a resource employed by a telecommunications switching system. Exemplary loads on the central processing unit card comprise handling of phone call traffic and reporting of information about events in the system. Some of the information reporting concerns critical events in the system. Other of the information reporting concerns routine operation, administration, and maintenance of the system.

From the perspective of a business that generates profits based primarily on phone call traffic, the handling of the phone call traffic represents an important responsibility for the central processing card. During peak call traffic, the central processing card can become overloaded from the loads of handling the phone call traffic and the reporting of critical information in addition to the reporting of routine information. As one shortcoming, the business loses opportunities to profit during the peak call traffic because the central processing card continues to perform the responsibility of reporting the routine information even when the central processing card cannot keep up with the phone calls.

One design allows a human operator to manually turn on or turn off categories of information that is reported. As one shortcoming, the involvement of the human operator involves an expense in attention required by the human operator and a potential source of error through possible occurrences of incorrect judgment exercised by the human operator.

Thus, a need exists for enhanced control of loads handled by a resource.

### SUMMARY

The invention in one embodiment encompasses an apparatus. The apparatus comprises one or more policies, a director component, and a control component. The one or more policies comprise one or more dynamically-updateable policies and zero or more fixed policies. The director component automatically employs information about one or more of a plurality of loads on a resource in conjunction with the one or more policies to automatically determine whether to decrease one or more loads of the one or more of the plurality of loads on the resource. Upon determination by the director component to decrease the one or more loads the director component automatically prepares an instruction to decrease the one or more loads. The control component, upon receipt of the instruction from the director component, automatically decreases the one or more loads on the resource. The one or more dynamically-updateable policies are changeable contemporaneously with active operation of the director component with the control component.

Another embodiment of the invention encompasses a method. There is automatically determined a state of heightened occupation of a resource during a time period. There is automatically determined, through employment of one or more policies during the time period, the resource is to handle one or more higher-importance loads during the time period. There is automatically decreased one or more lesser-importance loads on the resource during the time period.

A further embodiment of the invention encompasses an article. The article comprises one or more computer-readable signal-bearing media. The article comprises means in the one or more media for automatically determining a state of heightened occupation of a resource during a time period. The article comprises means in the one or more media for automatically determining, through employment of one or more policies during the time period, the resource is to handle one or more higher-importance loads during the time period. The article comprises means in the one or more media for automatically decreasing one or more lesser-importance loads on the resource during the time period.

### DESCRIPTION OF THE DRAWINGS

Features of exemplary implementations of the invention will become apparent from the description, the claims, and the accompanying drawings in which:

FIG. 1 is a representation of one exemplary implementation of one exemplary location of subcomponents among components of an apparatus that comprises and/or couples with one another one or more network management systems, one or more operation support systems, one or more gateways, one or more processes, and one or more cards.

FIG. 2 is a representation of one exemplary implementation of one exemplary location of subcomponents among components of the apparatus of FIG. 1, further illustrating that the apparatus comprises and/or couples with one another the one or more network management systems, the one or more operation support systems, the one or more gateways, the one or more processes, the one or more cards, one or more workstations, one or more dynamically-updateable policies, zero or more fixed policies, two or more control components, one or more director components, one or more resources, one or more notification components, one or more monitor components, one or more receiver components, one or more software applications, and one or more user interfaces.

FIG. 3 is a representation of one exemplary implementation of one exemplary location of subcomponents among components of the apparatus of FIG. 2, illustrating exemplary operation with redundancy.

FIG. 4 is a representation of one exemplary implementation of one exemplary location of subcomponents among components of the apparatus of FIG. 2, illustrating exemplary operation with load sharing.

### DETAILED DESCRIPTION

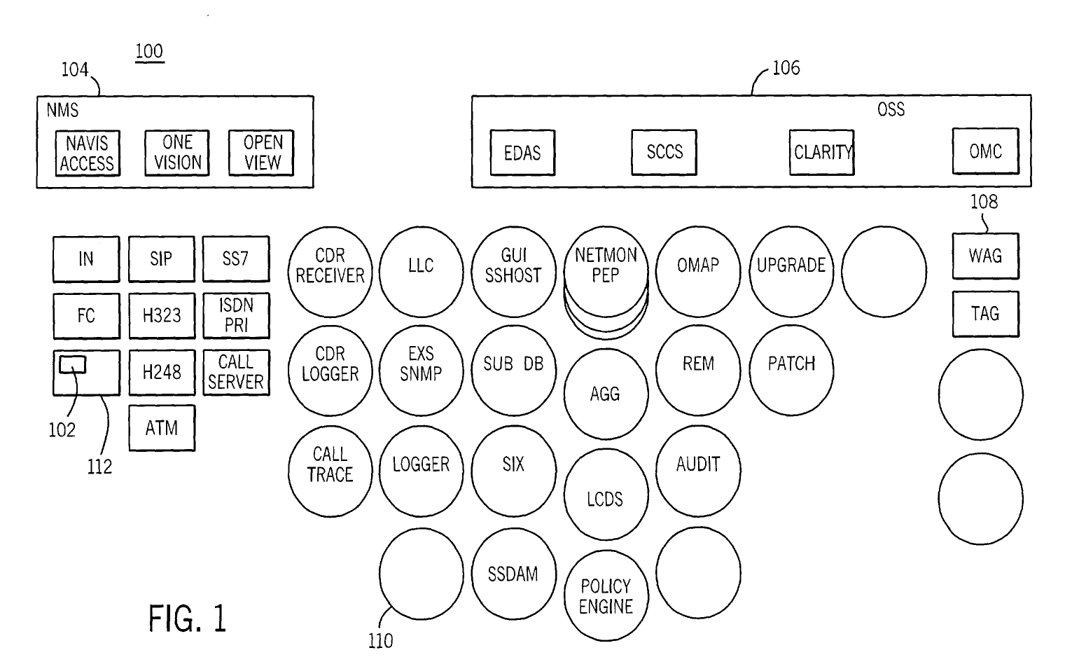

Turning to FIG. 1, an apparatus 100 in one example comprises one or more policies, a director component, and a control component. The one or more policies comprise one or more dynamically-updateable policies and zero or more fixed policies. The director component automatically employs information about one or more of a plurality of loads on a resource in conjunction with the one or more policies to automatically determine whether to decrease one or more loads of the one or more of the plurality of loads on the resource. Upon determination by the director component to decrease the one or more loads the director component automatically prepares an instruction to decrease the one or more loads. The control component, upon receipt of the instruction from the director component, automatically decreases the one or more loads on the resource. The one or more dynamically-updateable policies are changeable contemporaneously with active operation of the director component with the control component. The apparatus 100 comprises a plurality of components such as computer software and/or hardware components. A number of such components can be combined or divided in the apparatus 100.

The apparatus 100 in one example employs one or more computer-readable signal-bearing media. One example of a computer-readable signal-bearing medium for the apparatus 100 comprises an instance of a recordable data storage medium 102 such as one or more of a magnetic, electrical, optical, biological, and atomic data storage medium. In another example, a computer-readable signal-bearing medium for the apparatus 100 comprises a modulated carrier signal transmitted over a network comprising or coupled with the apparatus 100, for instance, one or more of a telephone network, a local area network (“LAN”), the internet, and a wireless network. An exemplary component of the apparatus 100 employs and/or comprises a set and/or series of computer instructions written in or implemented with any of a number of programming languages, as will be appreciated by those skilled in the art.

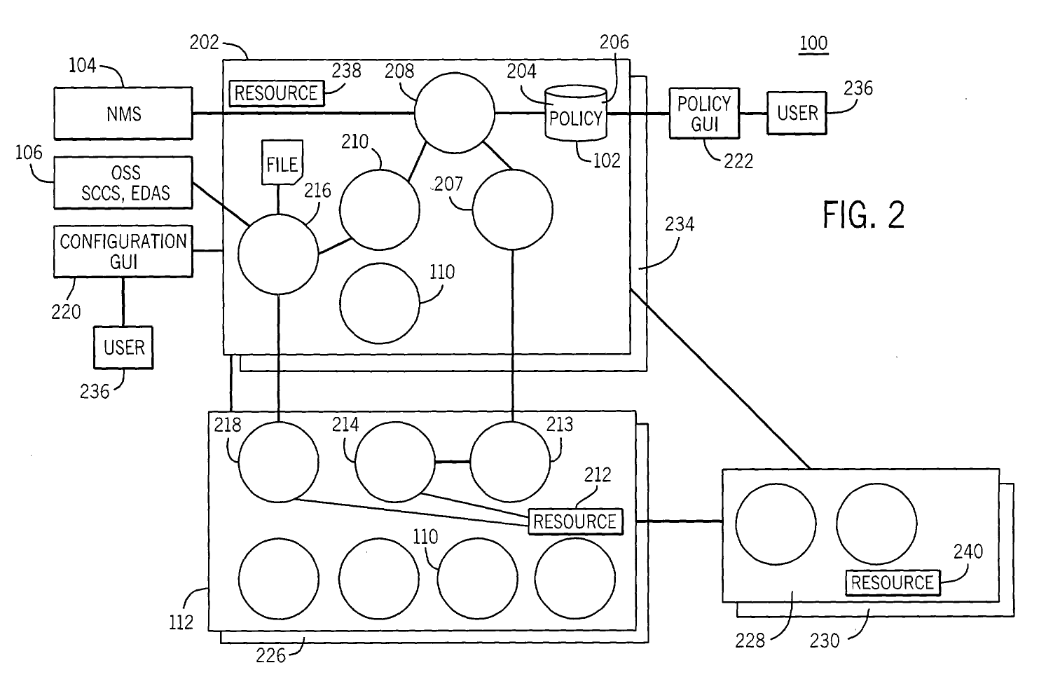

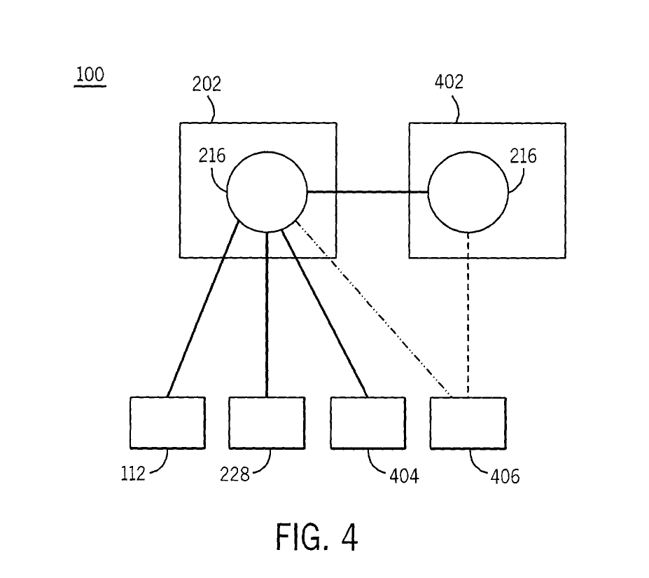

Referring to FIGS. 1-2, the apparatus 100 in one example comprises an operation, administration, and maintenance (“OA and M”) framework with built-in filtering and throttling and employment of one or more policies. For example, the apparatus 100 comprises and/or couples with one another one or more network management systems (“NMSs”) 104, one or more operation support systems (“OSSs”) 106, one or more gateways 108, one or more processes 110, one or more cards 112, 226, 228, 230, 404 (FIG. 4), and/or 406 (FIG. 4), one or more workstations 202, 234, and/or 402 (FIG. 4), one or more policies 204, zero or more policies 206, one or more first control components 207, one or more director components 208, one or more second control components 210, one or more resources 212, 238, and/or 240, one or more notification components 213, one or more monitor components 214, one or more receiver components 216, one or more software applications 218, and one or more user interfaces 220 and/or 222. The exemplary location of subcomponents among components represented in FIGS. 1-4 for explanatory purposes as well as illustrative modifications in the location of the subcomponents among the components are described in detail herein, as will be appreciated by those skilled in the art.

The network management system 104 manages network components of the apparatus 100. The network management system 104 employs, for example, one or more of Navis™ Access network management software and One Vision® software systems offered by Lucent Technologies Inc. and OpenView™ products and services offered by Hewlett-Packard Company. The operation support system 106 allows for engineering, design, planning, and measurement studies of networks of the apparatus 100. The operation support system 106 comprises, for example, one or more of an engineering and data acquisition system (“EDAS”), a switching control center system (“SCCS”), and Clarity™ Operational Support Systems offered by Clarity International Limited. In one example, the operation support system 106 comprises an operation and maintenance center (“OMC”). In another example, the network management system 104 comprises the operation and maintenance center. In yet another example, the operation support system 106 and the network management system 104 comprise the operation and maintenance center.

The engineering and data acquisition system of the operation support system 106 serves to produce reports to determine the quality of service (“QoS”) and identify problems in switching of the apparatus 100. The switching control center system of the operation support system 106 serves to monitor the availability of capabilities of the apparatus 100. The Clarity™ Operational Support System of the operation support system 106 serves to allow for specific parsing of reports of the apparatus 100.

The gateway 108 in one example serves to support the third generation (“3G”) of mobile cellular communications systems. The gateway 108 comprises, for example, one or more of a wireless access gateway (“WAG”) and a trunk access gateway (“TAG”). The gateways 108 in one example comprise one or more of the cards 112, 226, 228, 230, 404 (FIG. 4), and 406 (FIG. 4) and/or one or more of the workstations 202, 234, and 402 (FIG. 4), as will be appreciated by those skilled in the art.

The cards 112 and 228 and the workstation 202 in one example comprise the resources 212, 238, and 240, respectively. The resources 212, 238, and 240 in one example comprise one or more of an intelligence and processing capability. For example, the resources 212, 238, and 240 comprise respective processing components such as processors and/or central processing units (“CPUs”). The resources 212, 238, and 240 in one example serve to run a plurality of the processes 110, for example, individually or in a distributed fashion. In a further example, a plurality of the processes 110 are distributed over the workstations 202, 234, and 402 (FIG. 4). One or more of the processes 110 located on one or more of the workstations 202, 234, and 402 in one example serve to control one or more of the processes 110 located on one or more of the cards 112, 226, 228, 230, 404 (FIG. 4), and 406 (FIG. 4), as described herein.

The software application 218 in one example comprises one or more of the processes 110. For example, the processes 110 comprise one or more of call detailed records (“CDR”) receiver, call detailed records logger, call trace, low level communication (“LLC”), EXS simple network management protocol (“SNMP”) offered by Lucent Technologies Inc., logger, graphic user interface, SoftSwitch Host, subscriber database (“SUB DB”), SoftSwitch interface to extensible markup language (“XML,” collectively “SIX”) offered by Lucent Technologies Inc., subscriber database access manager (“SSDAM”), (e.g., Netmon™) policy enabling points (“PEPs”) offered by Lucent Technologies Inc., aggregator (“AGG”), Lucent common directory server (“LCDS”), policy engine, operation and maintenance application point (“OMAP”), redundancy element management (“REM”), Audit, Upgrade, and Patch.

One or more of the processes 110 that comprise the call detailed records logger provide accounting and billing information for calls of the apparatus 100. The call trace process serves to trace calls and identify the calling and called parties of the apparatus 100. The low level communication process serves to ensure reliable communication between one or more of the cards 112, 226, 228, 230, 404 (FIG. 4), and 406 (FIG. 4) and one or more of the workstations 202, 234, and 402 (FIG. 4). The logger serves to log information for debugging of the apparatus 100. The interfaces 220 and/or 222 comprise graphical user interfaces (“GUIs”), for example, that incorporate one or more icons, pull-down menus, and a mouse to allow the users 236 to interact with a computer. The interface 220 in one example comprises a configuration graphical user interface. The interface 222 in one example comprises a policy graphical user interface, as described herein. SoftSwitch Host serves to support graphic user interfaces and switch communication of the apparatus 100. The subscriber database, the SoftSwitch interface to extensible markup language offered by Lucent Technologies Inc., and the subscriber database access manager (“SSDAM”) serve to provide provisioning for one or more subscribers of the apparatus 100.

The Netmon™ architecture is policy-based, distributed, scalable, semi-fault tolerant, and directory-enabled to support automation and continuous monitoring of SoftSwitch network elements of the apparatus 100. The policy enabling points and the aggregator comprise policy decision-making points for policy management of the apparatus 100. The Lucent common directory server and the policy engine serve to support the policy management of the apparatus 100. The operation and maintenance application point and the redundancy element management serve to monitor the health of the processes 110 and the apparatus 100. The Audit process serves to check for inconsistency of the software and ensuring the integrity of the apparatus 100. The Upgrade and Patch processes serve to allow installation of a new release or performance of an update/replace operation of the software of the apparatus 100.

The cards 112, 226, 228, 230, 404 (FIG. 4), and 406 (FIG. 4) in one example comprise processor cards or central processing unit cards (“CPU cards”) or boards (“CPU boards”) located on a shelf. The cards 112, 226, 228, 230, 404, and 406 in one example comprise relatively-small, limited amounts (e.g., two megabytes) of memory space. In one example, one or more of the cards 112, 226, 228, 230, 404, and 406 comprise memory disks. In another example, one or more of the cards 112, 226, 228, 230, 404, and 406 are memory-diskless. In a further example, some of the cards 112, 226, 228, 230, 404, and 406 comprise memory disks and some of the cards 112, 226, 228, 230, 404, and 406 are memory-diskless. Exemplary capabilities and/or compatibilities of one or more of the cards 112, 226, 228, 230, 404, and 406 comprise one or more of intelligent network (“IN”), fibre channel (“FC”), session initiation protocol (“SIP”), the H.323 standard for realtime voice and videoconferencing over packet networks, the H248 standard for media gateway control, Asynchronous Transfer Mode (“ATM”), signaling system 7 (“SS7”) protocol for setting up calls and providing services, integrated services digital network (“ISDN”; telecommunications standard for providing digital service from the premises of a provider of telecommunications services to a dial-up telephone network) primary rate interface (“PRI”), and call server capabilities.

The cards 226 and 230 in one example serve as redundancy, standbys, and/or backups to the cards 112 and 228, respectively. The cards 112 and 226 in one example comprise a first type of card. The cards 228 and 230 in one example comprise a second type of card different from the first type of card. In one example, the cards 226 and 230 communicate with the cards 112 and 228, respectively. In another example, the cards 226 and 230 are operable without communication with the cards 112 and 228, respectively.

The workstations 202, 234, and 402 (FIG. 4) in one example comprise one or more memory disks with relatively-large amounts (e.g., one terabyte) of memory space. The workstation 234 in one example serves as redundancy, standby, and/or backup to the workstation 202, as described herein.

The resource 212 on the card 112 in one example sends information to the workstation 202 for storage because the workstation 202 comprises ample space on the memory disk. The information stored on the memory disk of the workstation 202 is available for viewing or retrieval upon storage and at subsequent times. Where the information comprises logging information, the apparatus 100 in one example employs the logging information for debugging and/or (e.g., subsequent) presentation, for example, to one or more providers of telecommunications services.

In one example of a telecommunications business, the provider of telecommunications services generates revenue when phone calls connect for which the provider can bill one or more subscribers of the telecommunications services. The apparatus 100 allows selection of tasks to perform through employment of one or more of the policies 204 and preservation and/or effective exploitation of one or more of the resources 212, 238, and 240, as described herein.

During one or more busy call periods (e.g., hours), the apparatus 100 in one example performs fewer operation, administration, and maintenance activities to provide capacity for handling phone calls to promote generation of revenue. For example, the apparatus 100 during one or more of the busy call periods drops (e.g., throttles) logging of information related to all events except alarms. The apparatus 100 in one example throttles logging of information related to one or more events such as audit, assert, measurement, upgrade, and redundancy messages.

The apparatus 100 in one example exercises dynamic control of use of the resources 212, 238, and/or 240 through employment of the one or more policies 204 and the zero or more policies 206. The policies 204 and/or 206 in one example comprise rules and/or regulations of an organization, for example, with a relationship to the apparatus 100. In one example, the policy 204 and/or 206 determines one or more types of the resources 212, 238, and/or 240 the users 236 are allowed to access, one or more types of the software application 118 the users 236 are allowed to install, and authority for the users 236 in reserving the resources 212, 238, and/or 240. In a further example, the policy 204 and/or 206 is related to network quality of service through definition of priorities by one or more of the users 236, one or more of workgroups of the users 236, and/or one or more of the software applications 118 for the users 236 with regard to reserving network bandwidth.

In a still further example, the policies 204 are dynamically-updateable and the policies 206 are fixed. So, subsequent to design, assembly, implementation, and/or installation of hardware and/or software of one implementation of the apparatus 100, the user 236 is allowed to access the interface 222 and change and/or update the policies 204, for example, contemporaneous with active operation of the apparatus 100 and in one example with the apparatus 100 immediately adopting and executing subsequent performance under the policies 204 as dynamically-updated. In another example, the policies 204 are updatable to accomplish goals foreseeable or unforeseeable at any time previous to an update or design, assembly, implementation, and/or installation of the apparatus 100. In a further example, the policies 206 are set, for example, by the organization regarding matters expected to have substantial continuity notwithstanding updates of the policies 204.

One or more users 236 interact with the apparatus 100. The users 236 in one example comprise one or more human operators. The first control component 207 controls the notification component 213. In one example, the first control component 207 comprises a policy enabling point and the notification component 213 comprises an alert and/or alarm component. The second control component 210 controls the receiver component 216. In one example, the second control component 210 comprises a policy enabling point. The receiver component 216 controls the software application 218. In one example, the receiver component 216 comprises a logger.

The director component 208 in one example receives information from all control components, for example all the first control components 207 and all the second control components 210, of the apparatus 100. For example, the director component 208 comprises an aggregator. In one example, the director component 208 one or more of collects, receives, and aggregates information communicated from the first control component 207 and the second control component 210, reads the policies 204 and/or 206, and decides whether any global action on the apparatus 100 needs to be done, as described herein.

One or more of the policies 204 and/or 206 in one example instruct the first control component 207 whether to take local action, for example, with respect to the notification component 213 or whether to pass information to the director component 208 for any possible instruction from the director component 208 to the first control component 207 and/or the second control component 210. One or more of the policies 204 and/or 206 in one example instruct the second control component 210 whether to take local action, for example, with respect to the receiver component 216 or whether to pass information to the director component 208 for any possible instruction from the director component 208 to the first control component 207 and/or the second control component 210. In a further example, the director component 208 initializes all the first control components 207 and all the second control components 210 consistent with the policies 204 and/or 206. In a still further example, the director component 208 updates corresponding ones of the first control components 207 and/or corresponding ones of the second control components 210 consistent with updates of the policies 204.

An illustrative description of exemplary operation of the apparatus 100 is now presented, for explanatory purposes. In one example, the user 236 employs the interface 220 to communicate with the workstation 202 and cause a monitoring situation to exist on the card 112, for example, by the user 236 causing an active status of a debug flag to be set on the card 112. In another example, the interface 220 automatically causes the monitoring situation to exist on the card 112, for example, through setting the active status of the debug flag on the card 112. In response to the active status of the debug flag on the card 112, the monitor component 214 evaluates usage of the resource 212. Exemplary usage of the resource 212 comprises responses to requests from and/or performance of tasks for one or more of the processes 110 on the card 112.

Upon determination and/or detection by the monitor component 214 that the resource 212 is overloaded, the monitor component 214 provides alarm information to the notification component 213. When the first control component 207 chooses to receive information from the notification component 213, the first control component 207 instructs the notification component 213 to send available (e.g., alarm) information from the notification component 213 to the first control component 207. The first control component 207 reports information gathered by the first control component 207 to the director component 208.

The director component 208 also receives information from the second control component 210. The second control component 210 reports information gathered by the second control component 210 to the director component 208. When the second control component 210 chooses to receive information from the receiver component 216, the second control component 210 instructs the receiver component 216 to send available information from the receiver component 216 to the second control component 210. The receiver component 216 reports information gathered by the receiver component 216 to the second control component 210. When the receiver component 216 chooses to receive information from the software application 218, the receiver component 216 instructs the software application 218 to send available information from the software application 218 to the receiver component 216.

The director component 208 receives information from all the first control components 207 and all the second control components 210, reads the policies 204 and/or 206, and decides whether any global action on the apparatus 100 needs to be done. Upon determination of usage of the resource 212 to be at a first level (e.g., below eighty-five percent of capacity), then the director component 208 accesses (e.g., checks) the policies 204 and/or 206 and determines that the resource 212 is fine and no extra action need be done, so a normal state continues. Upon determination of usage of the resource 212 to have increased from the first level to a second level (e.g., above eighty-five percent of capacity), then the director component 208 accesses (e.g., checks) the policies 204 and/or 206 and communicates with the control component 210 to cause the receiver component 216 to delay polling of the software application 218 and thereby free up the resource 212 from running the software application 218 to report information to the control component 210 and allow the resource 212 to allocate more processing power to network traffic.

Upon determination of usage of the resource 212 to have increased from the second level to a third level (e.g., above ninety percent of capacity), then the director component 208 accesses (e.g., checks) the policies 204 and/or 206 and communicates with the control component 210 to cause the receiver component 216 to throttle (e.g., decrease and/or stop) polling of the software application 218 of all non-essential and/or non-critical information and thereby free up the resource 212 from running the software application 218 and allow the resource 212 to allocate even more processing power to network traffic.

Upon determination of usage of the resource 212 to have decreased from the third level to a fourth level (e.g., below eighty percent of capacity to account for hysteresis), then the director component 208 accesses (e.g., checks) the policies 204 and/or 206 and communicates with the control component 210 to cause the receiver component 216 to resume polling of the software application 218 and thereby occupy at least some of the resource 212 in running the software application 218 to report information to the control component 210, so the normal state resumes.

In another example, the workstation 202 comprises additional ones of the processes 110 analogous to the first control component 210 and the receiver component 216 that serve to communicate with an additional one of the processes 110 on the card 112 analogous to the software application 218. In a further example, the director component 208 receives information from all the first control components 207 and all the second control components 210 on the card 112, reads the policies 204 and/or 206, and decides whether any global action on the apparatus 100 needs to be done.

In yet another example, the workstation 202 comprises additional ones of the processes 110 analogous to the first control component 210 and the receiver component 216 that serve to communicate with an additional one of the processes 110 on the card 228 analogous to the software application 218. In a still further example, the director component 208 receives information from all the first control components 207 and all the second control components 210 on the cards 112 and 228, reads the policies 204 and/or 206, and decides whether any global action on the apparatus 100 needs to be done.

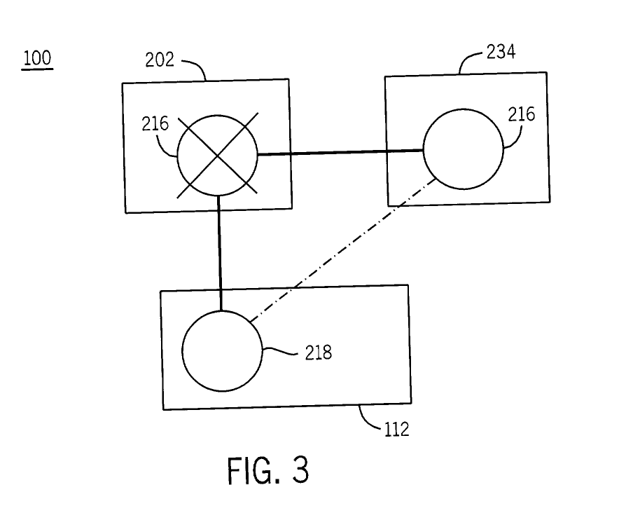

An illustrative description of exemplary operation with redundancy is now presented, for explanatory purposes. Turning to FIG. 3, the receiver component 216 on the workstation 202 in one example fails. One of the processes 110 that comprises the operation and maintenance application point in one example attempts to restart the receiver component 216 on the workstation 202. If successful, then the receiver component 216 on the workstation 202 resumes and/or continues communication with the software application 218, as described herein. If unsuccessful or the process 110 that comprises the operation and maintenance application point determines the workstation 202 has failed, then the operation and maintenance application point causes the receiver component 216 on the workstation 234 to substitute for the receiver component 216 on the workstation 202 with respect to communication with the software application 218, as described herein.

An illustrative description of exemplary operation with load sharing is now presented, for explanatory purposes. Turning to FIG. 4, the receiver component 216 on the workstation 202 in one example connects with the software applications 118 on the cards 112, 228, 404, and 406. In one example, the receiver component 216 on the workstation 202 communicates sharing information to the receiver component 216 on the workstation 402. In response, the receiver component 216 on the workstation 402 in one example connects with one or more of the software applications 218 on one or more of the cards 112, 228, 404, and 406 and replies to the receiver component 216 on the workstation 202 with connection information. For example, the receiver component 216 on the workstation 402 connects with the software application 118 on the card 406 and in response the receiver component 216 on the workstation 202 disconnects from the software application 118 on the card 406 to free up at least some of the resource 238 on the workstation 202.

In another example, the receiver component 216 on the workstation 202 communicates a request for load sharing with the receiver component 216 on the workstation 402 but the receiver component 216 on the workstation 402 is loaded and therefore communicates to the receiver component 216 on the workstation 202 that the receiver component 216 on the workstation 402 is unavailable for any new connection. In one exemplary response, the receiver component 216 on the workstation 202 sends throttle messages to one or more (e.g., all) of the cards 112, 228, 404, and 406. In another exemplary response, the receiver component 216 on the workstation 202 communicates a (e.g., alternative) request for load sharing with the receiver component 216 on another workstation (not shown) of the apparatus 100.

Additional illustrative description of exemplary operation of the apparatus 100 is now presented, for explanatory purposes. The apparatus 100 employs one or more policies that comprise one or more of the policies 204 that are dynamically-updateable and zero or more of the policies 206 that are fixed. The director component 208 automatically employs information about one or more of a plurality of loads on the resource 212, 238, or 240 in conjunction with the one or more policies (that comprise the one or more of the policies 204 and the zero or more of the policies 206) to automatically determine whether to decrease one or more loads of the one or more of the plurality of loads on the resource 212, 238, or 240. Upon determination by the director component 208 to decrease the one or more loads the director component 208 automatically prepares an instruction to decrease the one or more loads. The control component 210, upon receipt of the instruction from the director component 208, automatically decreases the one or more loads on the resource 212, 238, or 240. The one or more policies 204 are changeable contemporaneous with active operation of the director component 208 with the control component 210.

In one example, the director component 208 and the control component 210 are located on one or more of the workstations 202 and 234 and the monitor component 214 is located on the card 112. The monitor component 214 automatically obtains the information. The monitor component 214 automatically communicates the information to the director component 208. The resource 212, 238, or 240 is located on the card 112.

The instruction comprises a first instruction and the control component 210, upon receipt of the first instruction from the director component 208, automatically prepares a second instruction to decrease the one or more loads. The receiver component 216 is located on one of the workstations 202 and 234. The receiver component 216, upon receipt of the second instruction from the control component 210, automatically instructs a software application 218 on the card 112 to decrease an amount of event-reporting information automatically sent from the software application 218 to the receiver component 216.

In another example, the director component 208 and the control component 210 are located on one or more of the workstations 202 and 234, the monitor component 214 is located on the card 112, and the resource 212, 238, or 240 is located on the card 228. The monitor component 214 automatically obtains the information. The monitor component 214 automatically communicates the information to the director component 208.

The instruction comprises a first instruction and the control component 210, upon receipt of the first instruction from the director component 208, automatically prepares a second instruction to decrease the one or more loads. The receiver component 216 is located on one of the workstations 202 and 234. The receiver component 216, upon receipt of the second instruction from the control component 210, automatically instructs the software application 218 on the card 228 to decrease an amount of event-reporting information automatically sent from the software application 218 to the receiver component 216.

In yet another example, the director component 208 and the control component 210 are located on one or more of the workstations 202 and 234, the monitor component 214 is located on one of the workstations 202 and 234, and the resource 212, 238, or 240 is located on the one of the workstations 202 and 234. The monitor component 214 automatically obtains the information. The monitor component 214 automatically communicates the information to the director component 208.

The instruction comprises a first instruction and the control component 210, upon receipt of the first instruction from the director component 208, automatically prepares a second instruction to decrease the one or more loads. The receiver component 216 is located on the one of the workstations 202 and 234. The receiver component 216, upon receipt of the second instruction from the control component 210, automatically instructs the software application 218 on the one of the workstations 202 and 234 to decrease an amount of event-reporting information automatically sent from the software application 218 to the receiver component 216.

In an additional example, the director component 208, the control component 210, the monitor component 214, and the resource 212, 238, or 240 are located on the workstation 202. The monitor component 214 automatically obtains the information. The monitor component 214 automatically communicates the information to the director component 208.

The instruction comprises a first instruction and the control component 210, upon receipt of the first instruction from the director component 208, automatically prepares a second instruction to decrease the one or more loads. The receiver component 216 is located on the workstation 202. The receiver component 216, upon receipt of the second instruction from the control component 210, automatically instructs the software application on the workstation 202 to decrease an amount of event-reporting information automatically sent from the software application 218 to the receiver component 216.

In a further example, the information relates to one or more operation, administration, and maintenance activities of the resource 212, 238, or 240. The one or more operation, administration, and maintenance activities comprise a subset of the plurality of loads on the resource 212, 238, or 240. The director component 208 automatically employs the information in conjunction with the one or more policies (that comprise the one or more of the policies 204 and the zero or more of the policies 206) to automatically determine whether to decrease one or more of the one or more operation, administration, and maintenance activities of the resource 212, 238, or 240. Upon determination by the director component 208 to decrease the one or more of the one or more operation, administration, and maintenance activities of the resource 212, 238, or 240 the director component 208 automatically prepares an instruction to decrease the one or more of the one or more operation, administration, and maintenance activities of the resource 212, 238, or 240. The control component 210, upon receipt of the instruction from the director component 208, automatically decreases the one or more of the one or more operation, administration, and maintenance activities of the resource 212, 238, or 240.

The resource 212, 238, or 240 comprises a communications resource. The information relates to phone traffic handled by the communications resource. The director component 208 automatically employs the information in conjunction with the one or more policies (that comprise the one or more of the policies 204 and the zero or more of the policies 206) to automatically determine whether to decrease an amount of event-reporting information automatically input to the receiver component 216. Upon determination by the director component 208 to decrease the amount of the event-reporting information automatically input to the receiver component 216 the director component 208 automatically prepares an instruction to decrease the amount of the event-reporting information automatically input to the receiver component 216. The control component 210, upon receipt of the instruction from the director component 208, automatically instructs the receiver component 216 to decrease the amount of the event-reporting information automatically input to the receiver component 216.

In one example, the control component 210, upon receipt of the instruction from the director component 208, automatically instructs the receiver component 216 to stop receipt of the event-reporting information. In another example, the instruction from the director component 208 comprises a first instruction from the director component 208 and the control component 210, upon receipt of the first instruction from the director component 208, automatically instructs the receiver component 216 to receive the event-reporting information at a decreased rate. The control component 210, upon receipt of a second instruction from the director component 208, automatically instructs the receiver component 216 to stop receipt of the event-reporting information.

In yet another example, the instruction from the director component 208 comprises a first instruction from the director component 208 and the control component 210, upon receipt of a second instruction from the director component 208, automatically instructs the receiver component 216 to increase an amount of the event-reporting information automatically input to the receiver component 216. In a further example, the one or more loads on the communications resource comprise one or more loads of the software application 218. The instruction comprises a first instruction and the control component 210, upon receipt of the first instruction from the director component 208, automatically prepares a second instruction to decrease the amount of the event-reporting information automatically input to the receiver component 216. The receiver component 216, upon receipt of the second instruction from the control component 210, automatically instructs the software application 218 to decrease the amount of the event-reporting information automatically sent from the software application 218 to the receiver component 216.

In one example, the receiver component 216, upon receipt of the second instruction from the control component 210, automatically instructs the software application 218 to stop automatic transmission of the event-reporting information from the software application 218 to the receiver component 216. The receiver component 216, upon receipt of a third instruction from the control component 210, automatically instructs the software application 218 to resume the automatic transmission of the event-reporting information from the software application 218 to the receiver component 216.

In another example, the receiver component 216, upon receipt of the second instruction from the control component 210, automatically instructs the software application 218 to stop automatic collection of the event-reporting information by the software application 218. The receiver component 216, upon receipt of a third instruction from the control component 210, automatically instructs the software application 218 to resume the automatic collection of the event-reporting information by the software application 218.

The one or more policies 204 that are dynamically-updateable comprise one or more event-reaction policies. The director component 208 automatically and in real time employs the information in conjunction with the one or more policies (that comprise the one or more of the policies 204 and the zero or more of the policies 206) to automatically determine whether to decrease the one or more loads on the resource 212, 238, or 240. The one or more policies 204 that are dynamically-updateable comprise one or more policies created subsequent to implementation of the director component 208 and the control component 210 and initiation of the active operation of the director component 208 with the control component 210.

The one or more policies 204 that are dynamically-updateable effect one or more services that are new relative to implementation of the director component 208 and the control component 210 and initiation of the active operation of the director component 208 with the control component 210. The one or more policies 204 that are dynamically-updateable serve to allow reaction to one or more changes that arise subsequent to implementation of the director component 208 and the control component 210 and initiation of the active operation of the director component 208 with the control component 210.

Upon a failure, with respect to event-reporting information automatically sent from the software application 118 to the receiver component 216 located on the workstation 202, by the receiver component 216 the process 110 that comprises the operation and maintenance application point performs an attempt to restart the receiver component 216. Upon a failure of the attempt to restart the receiver component 216 the process 110 that comprises the operation and maintenance application point causes the receiver component 216 located on the workstation 234 to substitute for the receiver component 216 with respect to communication with the software application 218.

A receiver component 216 is located on the workstation 202. Another receiver component 216 is located on the workstation 402. The receiver component 216 on the workstation 202 executes a connection with the software applications 118 on the cards 112, 228, 404, and 406. The receiver component 216 on the workstation 202 performs a communication of sharing information with the receiver component 216 on the workstation 402. Upon performance of the communication of the sharing information from the receiver component 216 on the workstation 202 the receiver component 216 on the workstation 402 executes a connection with one or more of the software applications 118 on one or more of the cards 112, 228, 404, and 406 and replies to the receiver component 216 on the workstation 202 with connection information.

The resource 212, 238, or 240 is located on the workstation 202 and upon performance of the communication of the sharing information from the receiver component 216 on the workstation 202 the receiver component 216 on the workstation 402 executes a connection with one of the one or more of the software applications 118 on one of the one or more of the cards 112, 228, 404, and 406 and replies to the receiver component 216 on the workstation 202 with connection information. Upon execution of the connection with the one of the one or more of the software applications 118 by the receiver component 216 on the workstation 402 the receiver component 216 on the workstation 202 disconnects from the one of the one or more of the software applications 118 to free up at least some of the resource 212, 238, or 240 on the workstation 202.

There is automatically determined a state of heightened occupation of the resource 212, 238, or 240 during a time period. There is automatically determined, through employment of one or more policies during the time period, the resource 212, 238, or 240 is to handle one or more higher-importance loads during the time period. There are automatically decreased one or more lesser-importance loads on the resource 212, 238, or 240 during the time period.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
one or more policies that comprise one or more dynamically-updateable policies and zero or more fixed policies;
a director component that automatically employs information about one or more of a plurality of loads on a resource in conjunction with the one or more policies to automatically determine whether to decrease one or more loads of the one or more of the plurality of loads on the resource, wherein upon determination by the director component to decrease the one or more loads the director component automatically prepares an instruction to decrease the one or more loads; and
a control component that, upon receipt of the instruction from the director component, automatically decreases the one or more loads on the resource;
wherein the one or more dynamically-updateable policies are changeable contemporaneously with active operation of the director component with the control component.

2. The apparatus of claim 1, wherein the director component and the control component are located on one or more workstations, the apparatus further comprising:
a monitor component located on a processor card, wherein the monitor component automatically obtains the information, wherein the monitor component automatically communicates the information to the director component;
wherein the resource is located on the processor card.

3. The apparatus of claim 2, wherein the instruction comprises a first instruction;
wherein the control component, upon receipt of the first instruction from the director component, automatically prepares a second instruction to decrease the one or more loads;
the apparatus further comprising:
a receiver component located on one of the one or more workstations;
wherein the receiver component, upon receipt of the second instruction from the control component, automatically instructs a software application on the processor card to decrease an amount of event-reporting information automatically sent from the software application to the receiver component.

4. The apparatus of claim 1, wherein the director component and the control component are located on one or more workstations, the apparatus further comprising:
a monitor component located on a first processor card, wherein the monitor component automatically obtains the information, wherein the monitor component automatically communicates the information to the director component;
wherein the resource is located on a second processor card.

5. The apparatus of claim 4, wherein the instruction comprises a first instruction;
wherein the control component, upon receipt of the first instruction from the director component, automatically prepares a second instruction to decrease the one or more loads;
the apparatus further comprising:
a receiver component located on one of the one or more workstations;
wherein the receiver component, upon receipt of the second instruction from the control component, automatically instructs a software application on the second processor card to decrease an amount of event-reporting information automatically sent from the software application to the receiver component.

6. The apparatus of claim 1, wherein the director component and the control component are located on one or more workstations, the apparatus further comprising:
a monitor component located on one of the one or more workstations, wherein the monitor component automatically obtains the information, wherein the monitor component automatically communicates the information to the director component;
wherein the resource is located on the one of the one or more workstations.

7. The apparatus of claim 6, wherein the instruction comprises a first instruction;
wherein the control component, upon receipt of the first instruction from the director component, automatically prepares a second instruction to decrease the one or more loads;
the apparatus further comprising:
a receiver component located on the one of the one or more workstations;
wherein the receiver component, upon receipt of the second instruction from the control component, automatically instructs a software application on the one of the one or more workstations to decrease an amount of event-reporting information automatically sent from the software application to the receiver component.

8. The apparatus of claim 1, wherein the director component and the control component are located on a workstation, the apparatus further comprising:
a monitor component located on the workstation, wherein the monitor component automatically obtains the information, wherein the monitor component automatically communicates the information to the director component;
wherein the resource is located on the workstation.

9. The apparatus of claim 8, wherein the instruction comprises a first instruction;
wherein the control component, upon receipt of the first instruction from the director component, automatically prepares a second instruction to decrease the one or more loads;
the apparatus further comprising:
a receiver component located on the workstation;
wherein the receiver component, upon receipt of the second instruction from the control component, automatically instructs a software application on the workstation to decrease an amount of event-reporting information automatically sent from the software application to the receiver component.

10. The apparatus of claim 1, wherein the information relates to one or more operation, administration, and maintenance activities of the resource, wherein the one or more operation, administration, and maintenance activities comprise a subset of the plurality of loads on the resource;
wherein the director component automatically employs the information in conjunction with the one or more policies to automatically determine whether to decrease one or more of the one or more operation, administration, and maintenance activities of the resource, wherein upon determination by the director component to decrease the one or more of the one or more operation, administration, and maintenance activities of the resource the director component automatically prepares an instruction to decrease the one or more of the one or more operation, administration, and maintenance activities of the resource;
wherein the control component, upon receipt of the instruction from the director component, automatically decreases the one or more of the one or more operation, administration, and maintenance activities of the resource.

11. The apparatus of claim 1, wherein the resource comprises a communications resource;
wherein the information relates to phone traffic handled by the communications resource;
wherein the director component automatically employs the information in conjunction with the one or more policies to automatically determine whether to decrease an amount of event-reporting information automatically input to a receiver component, wherein upon determination by the director component to decrease the amount of the event-reporting information automatically input to the receiver component the director component automatically prepares an instruction to decrease the amount of the event-reporting information automatically input to the receiver component;
wherein the control component, upon receipt of the instruction from the director component, automatically instructs the receiver component to decrease the amount of the event-reporting information automatically input to the receiver component.

12. The apparatus of claim 11, wherein the control component, upon receipt of the instruction from the director component, automatically instructs the receiver component to stop receipt of the event-reporting information.

13. The apparatus of claim 11, wherein the instruction from the director component comprises a first instruction from the director component, wherein the control component, upon receipt of the first instruction from the director component, automatically instructs the receiver component to receive the event-reporting information at a decreased rate;
wherein the control component, upon receipt of a second instruction from the director component, automatically instructs the receiver component to stop receipt of the event-reporting information.

14. The apparatus of claim 11, wherein the instruction from the director component comprises a first instruction from the director component, wherein the control component, upon receipt of a second instruction from the director component, automatically instructs the receiver component to increase an amount of the event-reporting information automatically input to the receiver component.

15. The apparatus of claim 11 in combination with the receiver component, wherein the one or more loads on the communications resource comprise one or more loads of a software application, wherein the instruction comprises a first instruction;
wherein the control component, upon receipt of the first instruction from the director component, automatically prepares a second instruction to decrease the amount of the event-reporting information automatically input to the receiver component;
wherein the receiver component, upon receipt of the second instruction from the control component, automatically instructs the software application to decrease the amount of the event-reporting information automatically sent from the software application to the receiver component.

16. The apparatus of claim 15, wherein the receiver component, upon receipt of the second instruction from the control component, automatically instructs the software application to stop automatic transmission of the event-reporting information from the software application to the receiver component.

17. The apparatus of claim 16, wherein the receiver component, upon receipt of a third instruction from the control component, automatically instructs the software application to resume the automatic transmission of the event-reporting information from the software application to the receiver component.

18. The apparatus of claim 15, wherein the receiver component, upon receipt of the second instruction from the control component, automatically instructs the software application to stop automatic collection of the event-reporting information by the software application.

19. The apparatus of claim 18, wherein the receiver component, upon receipt of a third instruction from the control component, automatically instructs the software application to resume the automatic collection of the event-reporting information by the software application.

20. The apparatus of claim 1, wherein the one or more dynamically-updateable policies comprise one or more event-reaction policies, wherein the director component automatically and in real time employs the information in conjunction with the one or more policies to automatically determine whether to decrease the one or more loads on the resource.

21. The apparatus of claim 1, wherein the one or more dynamically-updateable policies comprise one or more policies created subsequent to implementation of the director component and the control component and initiation of the active operation of the director component with the control component.

22. The apparatus of claim 1, wherein the one or more dynamically-updateable policies effect one or more services that are new relative to implementation of the director component and the control component and initiation of the active operation of the director component with the control component.

23. The apparatus of claim 1, wherein the one or more dynamically-updateable policies serve to allow reaction to one or more changes that arise subsequent to implementation of the director component and the control component and initiation of the active operation of the director component with the control component.

24. The apparatus of claim 1, further comprising:
a process that comprises an operation and maintenance application point;
wherein upon a failure, with respect to event-reporting information automatically sent from a software application to a first receiver component, by the first receiver component located on a first workstation the process that comprises the operation and maintenance application point performs an attempt to restart the first receiver component;
wherein upon a failure of the attempt to restart the first receiver component the process that comprises the operation and maintenance application point causes a second receiver component located on a second workstation to substitute for the first receiver component with respect to communication with the software application.

25. The apparatus of claim 1, further comprising:
a first receiver component located on a first workstation; and
a second receiver component located on a second workstation;
wherein the first receiver component executes a connection with software applications on cards;
wherein the first receiver component performs a communication of sharing information with the second receiver component;
wherein upon performance of the communication of the sharing information from the first receiver component the second receiver component executes a connection with one or more of the software applications on one or more of the cards and replies to the first receiver component with connection information.

26. The apparatus of claim 25, wherein the resource is located on the first workstation;
wherein upon performance of the communication of the sharing information from the first receiver component the second receiver component executes a connection with one of the one or more of the software applications on one of the one or more of the cards and replies to the first receiver component with connection information;
wherein upon execution of the connection with the one of the one or more of the software applications by the second receiver component the first receiver component disconnects from the one of the one or more of the software applications to free up at least some of the resource.

27. A method, comprising the steps of:
automatically determining a state of heightened occupation of a resource during a time period;
automatically determining, through employment of one or more policies during the time period, the resource is to handle one or more higher-importance loads during the time period; and
automatically decreasing one or more lesser-importance loads on the resource during the time period.

28. An article, comprising:
one or more computer-readable signal-bearing media; and
means in the one or more media for automatically determining a state of heightened occupation of a resource during a time period;
means in the one or more media for automatically determining, through employment of one or more policies during the time period, the resource is to handle one or more higher-importance loads during the time period; and
means in the one or more media for automatically decreasing one or more lesser-importance loads on the resource during the time period.
